(19) United States
(12) Patent Application Publication
(10) Pub. No.: US 2021/0350968 A1
(43) Pub. Date: Nov. 11, 2021

(54) REACTOR

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Kazuhiro Inaba, Yokkaichi-shi, Mie (JP)

(21) Appl. No.: 17/286,237

(22) PCT Filed: Sep. 30, 2019
(86) PCT No.: PCT/JP2019/038559

§ 371 Date: Apr. 16, 2021

(30) Foreign Application Priority Data
Oct. 19, 2018 (JP) JP 2018-197995

(51) Int. Cl. H01F 27/255; H01F 27/28; H01F 37/00; H01F 41/02

(52) U.S. Cl. CPC H01F 27/255; H01F 27/2823; H01F 2027/2842; H01F 41/0246; H01F 37/00

(57) ABSTRACT

A reactor includes a coil that includes a wound portion and a magnetic core that is arranged inside of the wound portion and outside of the wound portion, wherein the magnetic core is formed by combining a plurality of core pieces, at least one core piece of the plurality of core pieces is a first core piece constituted by a molded body of a composite material containing a magnetic powder and a resin, the first core piece includes a slit portion in a region arranged inside of the wound portion, a depth direction of the slit portion extends along a direction that intersects an axial direction of the first core piece, and the slit portion is provided so as to be open in an outer peripheral surface of the first core piece on one side of the depth direction and be closed on the other side.

### CROSS-REFERENCE TO RELATED APPLICATIONS

This application is the U.S. national stage of PCT/JP2019/038559 filed on Sep. 30, 2019, which claims priority of Japanese Patent Application No. JP 2018-197995 filed on Oct. 19, 2018, the contents of which are incorporated herein.

### TECHNICAL FIELD

The present disclosure relates to a reactor.

### BACKGROUND

JP 2017-135334A discloses, as a reactor to be used in an in-vehicle converter or the like, a reactor that includes a coil including a pair of wound portions, a magnetic core including a plurality of core pieces that are assembled in a ring shape, and a resin molded portion. The plurality of core pieces include a plurality of inner core pieces that are arranged inside of the wound portions and two outer core pieces that are arranged outside of the wound portions. The resin molded portion covers the outer periphery of the magnetic core. A portion of the resin molded portion that is inside a wound portion is interposed between adjacent inner core pieces and constitutes a resin gap portion.

A reactor in which magnetic saturation is unlikely to occur and that has excellent manufacturability is desired.

If a resin gap portion is provided between core pieces as described above, magnetic saturation is unlikely to occur in the reactor even if a large current value is used. However, in order to form the resin gap portion, a member, such as an inner interposed portion 51 in JP 2017-135334A, that keeps a gap between the adjacent core pieces at a predetermined size is necessary. Therefore, the number of parts is large. As a result of the number of parts being large, assembly time becomes long and manufacturability of the reactor is impaired.

In a case where a gap plate such as an alumina plate is provided instead of the resin gap portion described above, the number of parts is also large. Also, in a case where the core pieces and the gap plate are bonded with an adhesive as described in paragraph [0019] of the specification of JP 2017-135334A, time for solidifying the adhesive is necessary. For these reasons, manufacturability of the reactor is impaired.

Therefore, an object of the present disclosure is to provide a reactor in which magnetic saturation is unlikely to occur and that has excellent manufacturability.

### SUMMARY

A reactor according to the present disclosure includes a coil that includes a wound portion; and a magnetic core that is arranged inside of the wound portion and outside of the wound portion. The magnetic core is formed by combining a plurality of core pieces, at least one core piece of the plurality of core pieces is a first core piece that is constituted by a molded body of a composite material containing a magnetic powder and a resin. The first core piece includes a slit portion in a region that is arranged inside of the wound portion. A depth direction of the slit portion extends along a direction that intersects an axial direction of the first core piece, and the slit portion is provided so as to be open in an outer peripheral surface of the first core piece on one side of the depth direction and be closed on the other side.

### Effect of the Present Disclosure

Magnetic saturation is unlikely to occur in the reactor according to the present disclosure, and the reactor has excellent manufacturability.

### BRIEF DESCRIPTION OF DRAWINGS

FIG. 1 is a schematic plan view showing a reactor according to a first embodiment.

FIG. 2A is a schematic perspective view showing a first core piece included in the reactor according to the first embodiment.

FIG. 2B is a schematic plan view showing the first core piece included in the reactor according to the first embodiment.

FIG. 2C is a schematic front view showing the first core piece included in the reactor according to the first embodiment.

FIG. 2D is a schematic side view of the first core piece included in the reactor according to the first embodiment, viewed from an axial direction of the first core piece.

FIG. 3A is a schematic plan view showing another example of the first core piece included in the reactor according to the first embodiment.

FIG. 3B is a schematic plan view showing another example of the first core piece included in the reactor according to the first embodiment.

FIG. 3C is a schematic plan view showing another example of the first core piece included in the reactor according to the first embodiment.

FIG. 3D is a schematic plan view showing another example of the first core piece included in the reactor according to the first embodiment.

FIG. 4 is a schematic plan view showing a reactor according to a second embodiment.

### DETAILED DESCRIPTION OF PREFERRED EMBODIMENTS

First, aspects of implementation of the present disclosure will be listed and described.

A reactor according to an aspect of the present disclosure includes a coil that includes a wound portion; and a magnetic core that is arranged inside of the wound portion and outside of the wound portion. The magnetic core is formed by combining a plurality of core pieces. At least one core piece of the plurality of core pieces is a first core piece that is constituted by a molded body of a composite material containing a magnetic powder and a resin. The first core piece includes a slit portion in a region that is arranged inside of the wound portion, a depth direction of the slit portion extends along a direction that intersects an axial direction of the first core piece, and the slit portion is provided so as to be open in an outer peripheral surface of the first core piece on one side of the depth direction and be closed on the other side.

Magnetic saturation is unlikely to occur in the reactor according to the present disclosure and the reactor has excellent manufacturability as described below.

### Magnetic Characteristics

In the reactor according to the present disclosure, the first core piece is arranged such that the axial direction of the first core piece extends along an axial direction of the wound portion, i.e., a magnetic flux direction of the coil. As a result, the slit portion of the first core piece is arranged so as to intersect the magnetic flux direction. Such a slit portion can be used as a magnetic gap. Therefore, magnetic saturation is unlikely to occur in the reactor according to the present disclosure even if a large current value is used. Consequently, the reactor according to the present disclosure can maintain a predetermined inductance even if the large current value is used. Note that the depth direction of the slit portion referred to here is typically a direction that extends along a straight line that is drawn from an opening provided in the outer peripheral surface of the first core piece toward the inside of the first core piece to a bottom portion of the slit portion so as to have the maximum distance. Details will be described later. Note that the axial direction of the first core piece typically corresponds to a longitudinal direction of the first core piece.

The first core piece is the molded body of the composite material. The molded body of the composite material typically contains a large amount of resin, which is a non-magnetic material, when compared to a layered body of electromagnetic steel plates, a pressed powder molded body, or a pressed powder magnetic core. The molded body of the composite material contains resin in an amount of at least 10 vol %, for example. The resin contained in the composite material also functions as a magnetic gap, and therefore magnetic saturation is unlikely to occur in the reactor according to the present disclosure.

### Manufacturability

In the reactor according to the present disclosure, the first core piece includes the slit portion that functions as a magnetic gap. The first core piece and the magnetic gap are formed as a single molded body, and therefore it is possible to omit the above-described member that maintains a gap between adjacent core pieces, the above-described gap plate, and the like. The reactor according to the present disclosure has excellent manufacturability because the number of parts can be reduced and the time it takes to solidify an adhesive that bonds core pieces and the gap plate is not needed. Furthermore, the first core piece including the slit portion is the molded body of the composite material and therefore can be easily formed through injection molding or the like. For this reason too, the reactor according to the present disclosure has excellent manufacturability. Note that the magnetic gap formed by the slit portion may also be an air gap.

In addition, the reactor according to the present disclosure has low loss and a small size because the first core piece is the molded body of the composite material. Specifically, magnetic situation is unlikely to occur in the molded body of the composite material, when compared to a layered body of electromagnetic steel plates and a pressed powder molded body as described above. Accordingly, the thickness of the slit portion can be reduced. As a result of the thickness of the slit portion being small to a certain extent, a magnetic flux leakage from the slit portion is reduced. Even if the wound portion and the first core piece are arranged close to each other, a loss due to the magnetic flux leakage, e.g., a copper loss, is reduced. For this reason, the reactor according to the present disclosure has low loss. The composite material contains resin and has an excellent electrical insulation property, and the loss of eddy current is therefore reduced. An alternating current loss such as an iron loss is reduced, and therefore the reactor has low loss. Furthermore, the reactor according to the present disclosure has a small size because a gap between the wound portion and the first core piece can be made small. The gap between the wound portion and the first core piece can be made small owing to the excellent electrical insulation property described above. Note that the thickness of the slit portion referred to here is the maximum length along the axial direction of the first core piece.

Furthermore, the reactor according to the present disclosure has excellent strength although the first core piece includes the slit portion. This is because the volume of a region of the first core piece on the closed side of the slit portion can be made large to a certain extent, and mechanical strength can be easily increased.

In a second aspect of the reactor according to the present disclosure, a size of depth of the slit portion along a direction orthogonal to the axial direction is at least ⅓ and no greater than ½ of a length of the first core piece along the direction orthogonal to the axial direction.

The slit portion of this configuration effectively functions as a magnetic gap. Therefore, magnetic saturation is unlikely to occur in this configuration. Also, the slit portion of this configuration is not extremely deep. Therefore, the first core piece has excellent moldability. Also, the volume of the region of the first core piece on the closed side of the slit portion can be made large. Therefore, the reactor of this configuration has excellent manufacturability and excellent strength.

In a third aspect of the reactor according to the present disclosure, the first core piece includes a plurality of the slit portions.

In this configuration, the slit portions are open in the same direction or different directions at different positions in the axial direction of the first core piece. That is, each slit portion is provided such that not both sides of the depth direction of the slit portion are open in outer peripheral surfaces of the first core piece. Magnetic saturation is unlikely to occur in such a configuration, when compared to a case where each slit portion is provided so as to be open on both sides of the depth direction.

Also, this configuration includes the plurality of slit portions and therefore the thickness of each slit portion can be easily made small. The reactor of such a configuration has low loss even if the wound portion and the first core piece are arranged close to each other as described above. Also, the reactor of this configuration can be made small by arranging the wound portion and the core piece close to each other.

Furthermore, although this configuration includes the plurality of slit portions, the slit portions are formed at positions shifted from each other in the axial direction of the first core piece. Therefore, the volume of regions of the first core piece on the closed sides of the slit portions can be made large to a certain extent. The reactor of such a configuration also has excellent strength as described above.

In a fourth aspect of the reactor according to the present disclosure, the depth direction of the slit portion is a direction that extends along a short side of an imaginary rectangle that is the minimum rectangle in which an external shape of a cross section of the first core piece is included, the cross section being taken by cutting the first core piece along a plane that is orthogonal to the axial direction.

The slit portion of this configuration can be easily formed when compared to a case where the depth direction of the slit portion is a direction that extends along a long side of the imaginary rectangle. Therefore, this configuration further improves manufacturability.

In a fifth aspect of the reactor according to the present disclosure, the coil includes two said wound portions that are adjacent to each other, and the magnetic core includes: the first core piece including the slit portion arranged inside of one of the wound portions; and a second core piece that includes a region arranged inside of the other wound portion, is constituted by a molded body of the composite material, and does not include the slit portion.

The reactor of this configuration also has excellent heat dissipation performance as described below as a result of the first core piece including the slit portion and one of the wound portions in which the first core piece is arranged being arranged on a side that is close to a cooling mechanism. Here, assume that specifications such as compositions of the composite materials and shapes and sizes of the first core piece and the second core piece are substantially identical, except for the presence and the absence of the slit portion. In this case, it is likely that heat is generated in the one wound portion in which the first core piece including the slit portion is arranged, when compared to the other wound portion in which the second core piece that does not include the slit portion is arranged. This is because a copper loss is likely to be generated in the one wound portion due to a magnetic flux leakage from the slit portion. If the first core piece and the one wound portion, of which temperatures are more likely to be high, are arranged on the side close to the cooling mechanism and the second core piece and the other wound portion, of which temperatures are less likely to be high, are arranged on a side far from the cooling mechanism, the first core piece and the one wound portion can efficiently dissipate heat to the cooling mechanism. Note that the cooling mechanism may also be included in an installation target of the reactor.

Also, both the first core piece and the second core piece are the molded bodies of the composite material and can be easily formed through injection molding or the like. Therefore, this configuration further improves manufacturability.

Furthermore, the reactor of this configuration has low loss even if the wound portions and the core pieces are arranged close to each other as described above because both the first core piece and the second core piece are the molded bodies of the composite material. Also, the reactor of this configuration can be made small by arranging the wound portions and the core pieces close to each other.

In a sixth aspect of the reactor according to the present disclosure, a length of an opening edge of the slit portion along a peripheral direction of the first core piece is at least ⅓ and no greater than ½ of a perimeter of the first core piece.

It can be said that the slit portion of this configuration has a large opening. Such a first core piece has excellent moldability because a mold member for forming the slit portion can be easily taken out in a manufacturing step. Therefore, this configuration further improves manufacturability. Also, the slit portion of this configuration is not extremely large, and the volume of the region of the first core piece on the closed side of the slit portion can be made large. Therefore, the reactor of this configuration also has excellent strength.

In a seventh aspect of the reactor according to the present disclosure, a relative permeability of the molded body of the composite material is at least 5 and no greater than 50, and a relative permeability of a third core piece that is arranged outside of the wound portion is at least two times the relative permeability of the molded body of the composite material.

With this configuration, it is easy to make the reactor small while achieving a large inductance, when compared to a case where the molded body of the composite material and the third core piece have the same relative permeability that is 5 to 50. The molded body of the composite material referred to here constitutes the first core piece, or the first core piece and the second core piece in the configuration described above in the fifth aspect.

Also, the relative permeability of the molded body of the composite material is relatively low. Magnetic saturation is unlikely to occur in a configuration that includes the molded body of the composite material having such a low permeability. Since magnetic saturation is unlikely to occur, the thickness of the slit portion can be reduced. If the thickness of the slit portion is small, a magnetic flux leakage from the slit portion is reduced. Also, even if the wound portion is arranged close to the first core piece or the second core piece as described above, a loss is reduced. The reactor having such a configuration has low loss and a small size as described above.

Furthermore, with this configuration, a magnetic flux leakage between the third core piece and the first core piece or the second core piece is reduced. The reactor having such a configuration has low loss because a loss due to the above-described magnetic flux leakage is reduced.

In an eighth aspect of the reactor described above in the seventh aspect, the relative permeability of the third core piece is at least 50 and no greater than 500.

This configuration makes it easy to increase the difference in relative permeability between the third core piece and the first core piece or the second core piece. Therefore, with this configuration, the magnetic flux leakage between the third core piece and the first core piece or the second core piece can be further reduced, and the reactor has lower loss.

In a ninth aspect of the reactor described above, the reactor includes a resin molded portion that covers at least a portion of the magnetic core.

This configuration includes a plurality of core pieces, but the plurality of core pieces can be held by the resin molded portion. The resin molded portion increases strength of the magnetic core as a single piece, and accordingly the reactor of this configuration has excellent strength. Also, with this configuration, it is possible to improve electrical insulation between the coil and the magnetic core, protect the magnetic core from an external environment, and mechanically protect the magnetic core by using the resin molded portion.

Hereinafter, embodiments of the present disclosure will be described in detail with reference to the drawings. Objects with the same names are denoted by the same reference numerals in the drawings.

### First Embodiment

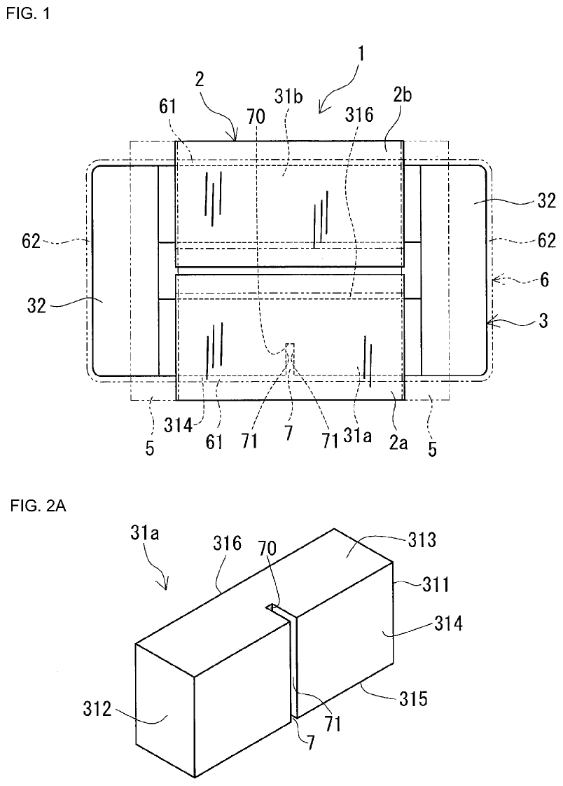

A reactor 1 according to a first embodiment will be described with reference to FIGS. 1 to 3D.

FIG. 1 is a plan view of the reactor 1 according to the first embodiment viewed from a direction that is orthogonal to both axial directions of wound portions 2a and 2b of a coil 2 and a direction in which the two wound portions 2a and 2b are arranged. Here, the axial directions correspond to the left-right direction in FIG. 1. The direction in which the wound portions 2a and 2b are arranged corresponds to the up-down direction in FIG. 1. The direction orthogonal to these directions corresponds to the direction perpendicular to the sheet face of FIG. 1.

### Overview

As shown in FIG. 1, the reactor 1 of the first embodiment includes the coil 2 that includes the wound portions and a magnetic core 3 that is arranged inside and outside of the wound portions. The coil 2 in the present example includes the two wound portions 2a and 2b that are adjacent to each other. The wound portions 2a and 2b are arranged such that their axes are parallel to each other. The magnetic core 3 is formed by combining a plurality of core pieces. The magnetic core 3 in the present example includes a first core piece 31a including a region thereof that is arranged inside of one of the wound portions, which is the wound portion 2a, a second core piece 32b including a region thereof that is arranged inside of the other wound portion 2b, and third core pieces 32 that are arranged outside of the wound portions 2a and 2b. The magnetic core 3 is formed by assembling these core pieces 31a, 31b, and 32 in a ring shape. The core pieces 31a and 31b are arranged such that their axial directions extend along axial directions of the wound portions 2a and 2b. The two core pieces 32 are arranged so as to sandwich the core pieces 31a and 31b. This kind of reactor 1 is typically used by being attached to an installation target (not shown) such as a converter case.

In particular, the reactor 1 of the first embodiment includes the first core piece 31a that includes a slit portion 7, as a core piece constituting the magnetic core 3. Also, the first core piece 31a is a molded body that contains resin. Specifically, at least one core piece of the plurality of core pieces is the first core piece 31a constituted by the molded body of a composite material that contains a magnetic powder and resin. The first core piece 31a includes the slit portion 7 in a region that is arranged inside of the wound portion 2a. A depth direction of the slit portion 7 extends along a direction that intersects the axial direction of the first core piece 31a. The slit portion 7 is provided so as to be open in an outer peripheral surface of the first core piece 31a on one side of the depth direction and be closed on the other side.

The depth direction of the slit portion 7 is typically a direction that extends along a straight line that is drawn from an opening of the slit portion 7 provided in the first core piece 31a toward the inside of the first core piece 31a to a bottom portion of the slit portion 7, which is an inner bottom surface 70 in FIG. 1, so as to have the maximum distance. In a case where the slit portion 7 is formed by the single inner bottom surface 70 and two inner wall surfaces 71 that are arranged in parallel with each other as is the case with the present example, the depth direction of the slit portion 7 extends along the inner wall surfaces 71. In the present example, the depth direction of the slit portion 7 is a direction orthogonal to the axial direction of the first core piece 31a. The axial direction corresponds to the left-right direction in FIG. 1. The direction orthogonal to the axial direction corresponds to the up-down direction in FIG. 1.

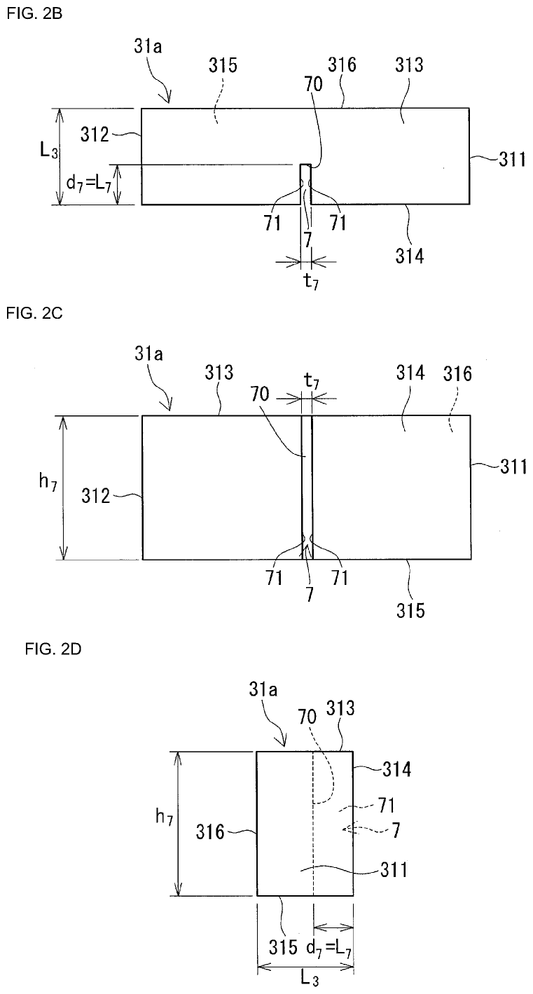

Also, the first core piece 31a in the present example has a rectangular parallelepiped shape (FIG. 2A). Accordingly, outer peripheral surfaces of the first core piece 31a include two end surfaces 311 and 312 and four peripheral surfaces 313 to 316. The slit portion 7 in the present example is provided so as to be open in the peripheral surface 314 located on one side of the depth direction, out of the outer peripheral surfaces of the first core piece 31a, and be closed in the peripheral surface 316 located on the other side of the depth direction. That is, the slit portion 7 is provided so as to have an opening in the peripheral surface 314 and not to have an opening in the other peripheral surface 316 of the opposite peripheral surfaces 314 and 316.

Note that, in a case where inner peripheral surfaces forming the slit portion 7 include a plurality of inner bottom surfaces (not shown), the depth direction of the slit portion 7 is defined as follows. A cross section of the first core piece 31a is taken by cutting the first core piece 31a along a plane that is orthogonal to the axial direction of the first core piece 31a. Assume the minimum rectangle in which the external shape of the cross section is included. The slit portion 7 is projected onto the imaginary rectangle. In the projected image of the slit portion 7, a direction that extends along a short side of the rectangle or a long side of the rectangle is taken to be the depth direction of the slit portion 7. Note that the case where the inner peripheral surfaces include a plurality of inner bottom surfaces is, for example, a case where the slit portion 7 is provided in a corner portion of the first core piece 31a having a rectangular parallelepiped shape and is formed by two inner bottom surfaces that are arranged in an L-shape and two wall surfaces.

The first core piece 31a is arranged such that the axial direction of the first core piece 31a extends along the axial direction of the wound portion 2a, i.e., a magnetic flux direction of the coil 2. As a result, the slit portion 7 is arranged so as to intersect the magnetic flux direction of the coil 2. The slit portion 7 in the present example is arranged to be orthogonal to the magnetic flux direction of the coil 2. Such a slit portion 7 functions as a magnetic gap and contributes to making magnetic saturation unlikely to occur in the reactor 1. Also, the slit portion 7 and the first core piece 31a are formed as a single piece, and this contributes to a reduction in the number of assembled parts of the reactor 1. Note that the axial direction of the first core piece 31a referred to here corresponds to the longitudinal direction of the core piece 31a.

Hereinafter, each constituent element will be described in detail.

### Coil

The coil 2 in the present example includes the wound portions 2a and 2b that have tube shapes and are obtained by winding winding wires (not shown) into spiral shapes. Example configurations of the coil 2 including the two adjacent wound portions 2a and 2b include the following configurations.

Configuration (i) The coil 2 includes the wound portions 2a and 2b that are formed from two independent winding wires and a connection portion (not shown). The connection portion is formed by connecting end portions on one side of both end portions of the winding wires pulled out from the winding portions 2a and 2b.

Configuration (ii) The coil 2 includes the wound portions 2a and 2b that are formed from one continuous winding wire and a joining portion (not shown). The joining portion is constituted by a portion of the winding wire spanning between the wound portions 2a and 2b and joins the wound portions 2a and 2b.

End portions of the winding wire pulled out from the wound portions 2a and 2b in the configuration (ii) and the other end portions that are not used in the connection portion in the configuration (i) are used as locations to which an external apparatus such as a power source is connected. The connection portion in the configuration (i) may have a configuration in which the end portions of the winding wires are directly connected to each other or a configuration in which the end portions of the winding wires are indirectly connected to each other. Welding, crimping, or the like can be used in the direct connection. Suitable metal fittings or the like that are attached to the end portions of the winding wires can be used in the indirect connection.

Examples of the winding wires include covered wires that include conductor wires and insulating coverings that cover outer peripheries of the conductor wires. Examples of the constituent material of the conductor wires include copper. Examples of the constituent material of the insulating coverings include resins such as polyamide imide. Specific examples of the covered wires include covered flat wires that have a rectangular cross-sectional shape and covered round wires that have a circular cross-sectional shape. Specific examples of wound portions 2a and 2b formed from flat wires include edgewise coils.

The wound portions 2a and 2b in the present example are square tube-shaped edgewise coils. Also, specifications such as the shapes, winding directions, and numbers of turns of the wound portions 2a and 2b are identical in the present example. The shapes, sizes, and the like of the winding wires and the wound portions 2a and 2b can be changed as appropriate. For example, the wound portions 2a and 2b may have circular tube shapes. Alternatively, for example, the specifications of the wound portions 2a and 2b may differ from each other.

### Magnetic Core

### Overview

The magnetic core 3 in the present example constitutes a closed magnetic path that is formed by combining a total of four core pieces, i.e., the core pieces 31a and 31b and the two core pieces 32 in a ring shape as described above. The first core piece 31a in the present example includes the slit portion 7 that is arranged inside of the wound portion 2a. The second core piece 31b in the present example includes a region thereof that is arranged inside of the other wound portion 2b and does not include the slit portion 7. In the present example, the two third core pieces 32 are arranged outside of the wound portions 2a and 2b and do not include the slit portion 7. The core pieces 31a and 31b that are mainly arranged inside of the wound portions 2a and 2b and the core pieces 32 that are arranged outside of the wound portions 2a and 2b are independent from each other. In this case, there is more freedom in choosing the constituent materials of the core pieces. In the present example, the constituent material of the core pieces 31a and 31b inside the coil 2 and the constituent material of the core pieces 32 outside the coil 2 differ from each other. The constituent materials of the core pieces 31a and 31b are the same. Also, the number of core pieces arranged inside of the single wound portion 2a or 2b is one. Therefore, the number of assembled parts of the magnetic core 3 is small, and consequently the number of assembled parts of the reactor 1 is small. The constituent materials of the core pieces and the number of core pieces can be changed as appropriate. Examples of modified configurations are described below as modified examples E and G.

### Shape and Size of Core Pieces

All of the core pieces 31a, 31b, and 32 in the present example have rectangular parallelepiped shapes. The core pieces 31a and 31b in the present example have substantially the same shape except for the presence and the absence of the slit portion 7 and have substantially the same size. The core pieces 31a and 31b each have an elongated rectangular parallelepiped shape and are arranged such that the longitudinal directions extend along the axial directions of the wound portions 2a and 2b as described above. The outer peripheral shapes of the core pieces 31a and 31b are approximately analogous to the inner peripheral shapes of the wound portions 2a and 2b. End surfaces 311 and 312 of each of the core pieces 31a and 31b have rectangular shapes and the length of the short sides thereof is smaller than the length of the long sides thereof (FIG. 2D). In the present example, the two core pieces 32 have the same shape and the same size. In each core piece 32, a surface to which the core pieces 31a and 31b are connected has an area that is larger than a total area of the two end surfaces 311 and 312. The sizes of the core pieces 31a, 31b, and 32 are adjusted according to the constituent materials, the size of the slit portion 7, and the like so that the reactor 1 satisfies predetermined magnetic characteristics.

Note that the shapes, the sizes, and the like of the core pieces 31a, 31b, and 32 can be changed as appropriate. For example, the shapes of the core pieces 31a and 31b may also be circular column shapes, polygonal column shapes, or the like. Also, the shape of the third core pieces 32 may also be a column shape that includes a dome-shaped surface shown in JP 2017-135334A or a trapezoidal surface, for example. In addition, at least one corner portion of corner portions of a core piece may also be C-chamfered or R-chamfered, for example. A chamfered corner portion is unlikely to be chipped, and a core piece including such a corner portion has excellent mechanical strength. Note that R-chamfered corner portions are shown in the third core pieces 32.

### Slit Portion

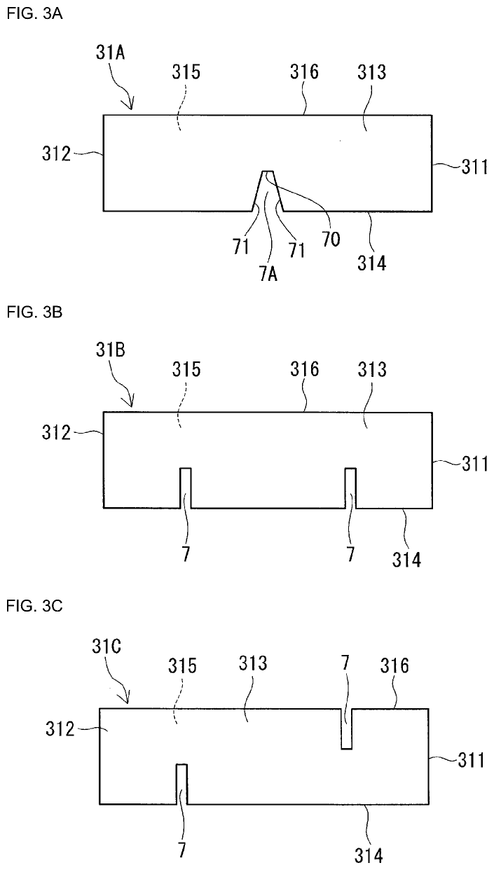

The following describes the slit portion 7 mainly with reference to FIGS. 2A to 2D and 3A to 3D.

The first core piece 31a includes at least one slit portion 7. The slit portion 7 is provided in the first core piece 31a so as to be open in an outer peripheral surface of the first core piece 31a on one side of the depth direction of the slit portion 7 and be closed on the other side. Such a slit portion 7 is open in a portion of the outer peripheral surface of the first core piece 31a. Also, the slit portion 7 is a recessed portion that does not extend through the first core piece 31a. The slit portion 7 typically has a thin plate-shaped interior space (FIG. 2A). As shown in FIGS. 3B to 3D, in cases where first core pieces 31B to 31D each include a plurality of slit portions 7, each slit portion 7 is provided such that not both sides of the depth direction of the slit portion 7 are open in outer peripheral surfaces of the core pieces 31B to 31D.

### Basic Configuration

The slit portion 7 in the present example is formed by the two inner wall surfaces 71 facing each other and the inner bottom surface 70 connecting the inner wall surfaces 71 (see FIG. 1, for example). Each inner wall surface 71 is provided so as to be orthogonal to the axial direction of the first core piece 31a. The inner bottom surface 70 is provided in parallel with the axial direction of the first core piece 31a. The slit portion 7 is open in the peripheral surface 314 located on one side of the depth direction of the slit portion 7 out of the outer peripheral surfaces of the first core piece 31a. The peripheral surface 316 located on the other side of the depth direction of the slit portion 7 is closed. That is, the peripheral surface 316 in the present example does not include a recessed portion and the entire peripheral surface 316 is constituted by a uniform flat surface. Furthermore, the slit portion 7 in the present example is also open in portions of the peripheral surfaces 313 and 315 that are continuous to the peripheral surface 314. Specifically, the slit portion 7 in the present example is provided so as to extend through the peripheral surfaces 313 and 315 and be continuously open in the three peripheral surfaces 313 to 315. The remaining one peripheral surface 316 is closed. As a result of the slit portion 7 being continuous in a peripheral direction of the first core piece 31a and being open spanning the plurality of peripheral surfaces 313 to 315, an opening edge is relatively long. The length of the opening edge is described below. The first core piece 31a including such a slit portion 7 has excellent moldability. This is because a mold member for forming the slit portion 7 can be easily taken out in a molding step of the first core piece 31a.

As shown in FIG. 2D, each inner wall surface 71 in the present example has a rectangular shape defined by a portal-shaped opening edge extending along the three peripheral surfaces 313 to 315 of the first core piece 31a and a straight line connecting both end portions of the opening edge. If the inner wall surfaces 71 have the shape defined by the opening edge and the straight line connecting both end portions of the opening edge, it can be said that the slit portion 7 has a simple shape. Accordingly, the first core piece 31a including the slit portion 7 has excellent moldability. In the present example, the inner bottom surface 70 also has a rectangular shape, and the interior space of the slit portion 7 has a rectangular parallelepiped shape. For this reason as well, the slit portion 7 has a simple shape and the first core piece 31a has excellent moldability.

The shapes of the inner wall surfaces 71 and the inner bottom surface 70 can be changed as appropriate. For example, the inner wall surfaces 71 may also have a shape that is defined by an opening edge and a curved line connecting both ends of the opening edge, and the inner bottom surface 70 may also have a curved shape that includes a curved surface. Alternatively, for example, the inner bottom surface 70 may also be omitted. Examples of such a case include a case where bottom portion side edges of the two inner wall surfaces 71 are joined and opening edges in the peripheral surfaces 313 and 315 have triangular shapes. In this case, the interior space of the slit portion 7 has a triangular prism shape.

In the present example, the inner wall surfaces 71 are substantially orthogonal to an outer peripheral surface, which is the peripheral surface 314 in this example, of the first core piece 31a. Accordingly, an intersection angle of the inner wall surfaces 71 relative to the outer peripheral surface, i.e., the peripheral surface 314, is 90°. The intersecting state of the inner wall surfaces 71 relative to the outer peripheral surface of the first core piece 31a, e.g., the intersection angle can be changed as appropriate. The intersection angle can be appropriately selected to be greater than 0° and less than 180°. For example, the inner wall surfaces 71 may also intersect the outer peripheral surface of the first core piece 31a at an angle other than 90°. A configuration in which the inner wall surfaces intersect the outer peripheral surface at an angle other than 90° is described later in a modified example D, i.e., is shown in FIG. 3A as a slit portion 7A included in a first core piece 31A.

### Depth Direction

The depth direction of the slit portion 7 only needs to intersect the axial direction of the first core piece 31a, i.e., intersect the magnetic flux direction of the coil 2. In particular, the closer the depth direction of the slit portion 7 is to a direction orthogonal to the magnetic flux direction of the coil 2, the more effectively the slit portion functions as a magnetic gap. The depth direction of the slit portion 7 in the present example is the direction orthogonal to the axial direction of the first core piece 31a, i.e., the direction orthogonal to the above-described magnetic flux direction (FIGS. 1 and 2B).

In an example configuration, the depth direction of the slit portion 7 is a direction that extends along a short side of an imaginary rectangle that is the minimum rectangle in which the external shape of a cross section of the first core piece 31a is included, the cross section being taken by cutting the first core piece 31a along a plane that is orthogonal to the axial direction of the first core piece 31a. The first core piece 31a in the present example has a rectangular parallelepiped shape. Accordingly, the cross section of the first core piece 31a taken along the plane orthogonal to the axial direction of the first core piece 31a has a rectangular shape. In this case, the external shape of the first core piece 31a can be used as is as the imaginary rectangle described above. If the first core piece 31a has an elliptical column shape or a column shape that includes a racetrack-shaped end surface, the cross section described above is taken. Then, the minimum rectangle in which the external shape of the cross section, e.g., an elliptical shape or a racetrack shape is included is taken to be the imaginary rectangle.

If the depth direction of the slit portion 7 extends along the direction of the short side of the imaginary rectangle, the first core piece 31a has excellent moldability and can be easily manufactured, when compared to a case where the depth direction extends along the direction of a long side of the imaginary rectangle. Consequently, the reactor 1 has excellent manufacturability. This is because the above-described mold member can be easily taken out even if a depth d₇ (FIGS. 2B and 2D) of the slit portion 7 is made relatively large. If the first core piece 31a has the rectangular parallelepiped shape shown in the present example or another simple shape such as an elliptical shape, the first core piece 31a has more excellent moldability and can be more easily manufactured.

The depth d₇ of the slit portion 7 referred to here is the maximum length of the slit portion 7 along the depth direction. In the present example, the depth d₇ is the maximum length along the direction orthogonal to the axial direction of the first core piece 31a. Note that a thickness t₇ (FIGS. 2B and 2C) of the slit portion 7, which will be described later, is the maximum length of the slit portion 7 along the axial direction of the first core piece 31a. A height h₇ (FIGS. 2C and 2D) of the slit portion 7, which will be described later, is the maximum length along a direction that is orthogonal to both the axial direction of the first core piece 31a and the depth direction.

### Size

The size of the slit portion 7, e.g., the thickness t₇, the depth d₇, the height h₇, and the length of the opening edge can be appropriately selected within ranges where the reactor 1 satisfies predetermined magnetic characteristics.

The larger the thickness t₇, the depth d₇, and the height h₇ are, the easier it is to make the internal volume of the slit portion 7 large. Magnetic saturation is unlikely to occur in a reactor 1 that includes a slit portion 7 having a large internal volume. Also, the larger the thickness t₇ is, the easier it is to take out the above-described mold member, and the first core piece 31a has excellent moldability.

On the other hand, the smaller the thickness t₇ and the height h₇ are, the easier it is to reduce a magnetic flux leakage from the slit portion 7. In a case where the slit portion 7 extends through the opposite peripheral surfaces as is the case with the present example, the smaller the depth d₇ is, the easier it is to reduce the above-described magnetic flux leakage. For these reasons, even if the wound portion 2a and the first core piece 31a are arranged close to each other, a loss due to the above-described magnetic flux leakage, e.g., a copper loss, is reduced. Also, if the wound portion and the first core piece are arranged close to each other, the reactor 1 can be easily made small. Therefore, the reactor 1 has low loss and a small size. In addition, the volume of a region of the first core piece 31a on the closed side of the slit portion 7 can be made large, and therefore mechanical strength of the first core piece 31a can be increased. As a result, the reactor 1 has high strength. Furthermore, the smaller the depth d₇ and the height h₇ are, the easier it is to take out the above-described mold member, and the first core piece 31a has excellent moldability.

Depending on the size of the magnetic core 3 or the like, if the thickness t₇ is at least 1 mm, for example, magnetic saturation is unlikely to occur in the reactor 1 and the first core piece 31a has excellent moldability. In a case where suppression of magnetic saturation and an improvement in manufacturability are desired, for example, the thickness t₇ may be at least 1.5 mm or at least 2 mm. If the thickness t₇ is no greater than 3 mm, for example, a magnetic flux leakage from the slit portion 7 can be easily reduced. Details of the depth d₇ are described in the following description of a length L₇. If the height h₇ is equal to the height of the first core piece 31a as shown in FIG. 2C, magnetic saturation is unlikely to occur in the reactor 1 and the first core piece 31a has excellent moldability. The height of the first core piece 31a is the distance between the opposite peripheral surfaces 313 and 315 in the present example.

For example, the slit portion 7 has the following size. The length L₇ (FIGS. 2B and 2D) of the depth d₇ of the slit portion 7 along the direction orthogonal to the axial direction of the first core piece 31a is at least ⅓ and no greater than ½ of a length L₃ (FIGS. 2B and 2D) of the first core piece 31a along the direction orthogonal to the axial direction of the first core piece 31a. In a case where the depth direction of the slit portion 7 is orthogonal to the axial direction of the first core piece 31a as is the case with the present example, the length L₇ of the slit portion 7 corresponds to the depth d₇. In a case where the depth direction of the slit portion 7 intersects the axial direction at an angle other than 90°, the length L₇ corresponds to a length obtained by projecting the depth d₇ of the slit portion 7 onto a plane that is orthogonal to the axial direction, which is the magnetic flux direction in this example. In the present example, the length L₃ of the first core piece 31a corresponds to the distance between the opposite peripheral surfaces 314 and 316. Furthermore, in the present example, the length L₃ of the first core piece 31a corresponds to the length along directions of short sides of the rectangular end surfaces 311 and 312. The length L₇ of the slit portion 7 in the present example is at least ⅓ and no greater than ½ of the length L₃ of the first core piece 31a.

If the length L₇ of the slit portion 7 is at least ⅓ of the length L₃ of the first core piece 31a, i.e., at least 33% of the length L₃, the slit portion 7 effectively functions as the magnetic gap. Therefore, magnetic saturation is unlikely to occur in the reactor 1. The longer the length L₇ of the slit portion 7 is, the larger the magnetic gap can be made and the less likely it is that magnetic saturation occurs in the reactor 1. In a case where suppression of magnetic saturation is desired, for example, the length L₇ of the slit portion 7 may be at least 35% of the length L₃ of the core piece 31a or at least 40% of the length L₃.

If the length L₇ of the slit portion 7 is no greater than ½ of the length L₃ of the first core piece 31a, i.e., no greater than 50% of the length L₃, the slit portion 7 is not extremely deep. Therefore, the above-described mold member can be easily taken out and the first core piece 31a has excellent moldability. Consequently, the reactor 1 has excellent manufacturability. Also, a magnetic flux leakage from the slit portion 7 can be easily reduced. For these reasons, the reactor 1 has low loss and a small size as described above. Also, as a result of the slit portion 7 being not extremely deep, the volume of the region of the first core piece 31a on the closed side of the slit portion 7 can be made large. For this reason, the reactor 1 has high strength as described above. The shorter the length L₇ of the slit portion 7 is, the easier it is to achieve these effects. In a case where an improvement in manufacturability, a reduction in loss, a reduction in size, and an improvement in strength are desired, for example, the length L₇ of the slit portion 7 may be no greater than 48% of the length L₃ of the core piece 31a or no greater than 45% of the length L₃.

The length of the opening edge of the slit portion 7 along the peripheral direction of the first core piece 31a may be at least ⅓ and no greater than ½ of the perimeter of the first core piece 31a, for example. The length of the opening edge in the present example is at least ⅓ and no greater than ½ of the perimeter of the first core piece 31a. The perimeter of the first core piece 31a referred to here is measured along the opening edge of the slit portion 7. In the present example, the perimeter of the first core piece 31a is the sum of the lengths of the four peripheral surfaces 313 to 316 along directions orthogonal to the axial direction of the first core piece 31a. The perimeter in the present example is equal to: 2×(h₇+L₃).

If the length of the opening edge of the slit portion 7 is at least ⅓ of the perimeter of the first core piece 31a, i.e., at least 33% of the perimeter, it can be said that the slit portion 7 has a large opening. The slit portion 7 is likely to have a large opening like the opening in the present example that continuously extends spanning the three peripheral surfaces 313 to 315, for example. As a result of the opening being large, the mold member for forming the slit portion 7 can be easily taken out even if the interior space of the slit portion 7 is large. Therefore, the first core piece 31a has excellent moldability. Consequently, the reactor 1 has excellent manufacturability. Also, if the interior space of the slit portion 7 is large, magnetic saturation is further suppressed in the reactor 1. The longer the opening edge is, the easier it is to achieve the above-described effects. In a case where an improvement in manufacturability and suppression of magnetic saturation are desired, for example, the length of the opening edge of the slit portion 7 may be at least 35% of the perimeter of the core piece 31a or at least 40% of the perimeter.

If the length of the opening edge of the slit portion 7 is no greater than ½ of the perimeter of the first core piece 31a, i.e., no greater than 50% of the perimeter, the slit portion 7 is not extremely large, and the volume of the region of the first core piece 31a on the closed side of the slit portion 7 can be made large. For this reason, the reactor 1 has high strength as described above. The shorter the opening edge is, the easier it is to achieve the above-described effect. In a case where an improvement in the strength is desired, for example, the length of the opening edge may be no greater than 48% of the perimeter of the core piece 31a or no greater than 45% of the perimeter.

In addition, the area of each inner wall surface 71 forming the slit portion 7 may satisfy the following. A cross section of the first core piece 31a is taken by cutting the first core piece 31a along a plane that is orthogonal to the axial direction of the first core piece 31a. Assume the minimum rectangle in which the external shape of the cross section is included. An area of the inner wall surface 71 projected onto the imaginary rectangle may be at least ⅓ and no greater than ½ of the area of the external shape of the above-described cross section. Hereinafter, the area of the inner wall surface 71 projected onto the imaginary rectangle will be referred to as a “projected area”. In the present example, the area of the inner wall surface 71 is equal to the projected area.

If the projected area of the inner wall surface 71 is at least ⅓ of the area of the external shape of the first core piece 31a in the above-described cross section, i.e., at least 33% of the area of the external shape, the slit portion 7 effectively functions as the magnetic gap. Therefore, magnetic saturation is unlikely to occur in the reactor 1. The larger the projected area of the slit portion 7 is, the less likely it is that magnetic saturation occurs in the reactor 1. In a case where suppression of magnetic saturation is desired, for example, the projected area of the slit portion 7 may be at least 35% or at least 40% of the area of the external shape of the above-described cross section.

On the other hand, if the projected area of the slit portion 7 is no greater than ½ of the area of the external shape of the first core piece 31a in the above-described cross section, i.e., no greater than 50% of the area of the external shape of the cross section, the slit portion 7 is not extremely deep. Therefore, the above-described mold member can be easily taken out and the first core piece 31a has excellent moldability. Consequently, the reactor 1 has excellent manufacturability. Also, a magnetic flux leakage from the slit portion 7 can be easily reduced. For these reasons, the reactor 1 has low loss and a small size as described above. Also, as a result of the slit portion 7 being not extremely deep, the volume of the region of the first core piece 31a on the closed side of the slit portion 7 can be made large. For this reason, the reactor 1 has high strength as described above. The smaller the projected area of the slit portion 7 is, the easier it is to achieve these effects. In a case where an improvement in manufacturability, a reduction in loss, a reduction in size, and an improvement in the strength are desired, for example, the projected area of the slit portion 7 may be no greater than 48% or no greater than 45% of the area of the external shape of the above-described cross section.

### Number of Slit Portions

The first core piece 31a shown in FIG. 1 includes the single slit portion 7. The first core pieces 31B to 31D shown in FIGS. 3B to 3D each include a plurality of slit portions 7. In the cases where the reactor 1 includes a plurality of slit portions 7, the slit portions 7 are provided at different positions in the axial directions of the first core pieces 31B to 31D and are open in the same direction or different directions. Also, each slit portion 7 is provided such that not both sides of the depth direction of the slit portion 7 are open in outer peripheral surfaces of the first core pieces 31B to 31D.

For example, the first core piece 31B shown in FIG. 3B includes two slit portions 7 that are shifted from each other in the axial direction of the first core piece 31B. The slit portions 7 are open in the same direction. Specifically, the slit portions 7 are open in the peripheral surface 314 and are not open in the peripheral surface 316. In the peripheral surface 316 out of the outer peripheral surfaces of the first core piece 31B, positions on the other sides of the depth directions of both slit portions 7 are closed.

For example, the first core piece 31C shown in FIG. 3C includes two slit portions 7 that are shifted from each other in the axial direction of the first core piece 31C. However, the slit portions 7 are open in different directions. Specifically, one of the slit portions 7, i.e., the slit portion 7 on the left side in FIG. 3C is open in the peripheral surface 314 and is not open in the peripheral surface 316. In the peripheral surface 316 out of the outer peripheral surfaces of the first core piece 31C, a position on the other side of the depth direction of this slit portion 7, i.e., a position on the left side in FIG. 3C is closed. The other slit portion 7, i.e., the slit portion 7 on the right side in FIG. 3C is open in the peripheral surface 316 and is not open in the peripheral surface 314. In the peripheral surface 314 out of the outer peripheral surfaces of the first core piece 31C, a position on the other side of the depth direction of the other slit portion 7, i.e., a position on the right side in FIG. 3C is closed. As described above, the first core piece 31C includes the two slit portions 7 that are shifted from each other in the axial direction and are open in opposite directions.

For example, the first core piece 31D shown in FIG. 3D includes three slit portions 7 that are shifted from each other in the axial direction of the first core piece 31D. In the present example, two slit portions 7 are open in the same direction and the remaining one slit portion 7 is open in a different direction. Specifically, the two slit portions 7 are open in the peripheral surface 314 and are not open in the peripheral surface 316. In the peripheral surface 316 out of the outer peripheral surfaces of the first core piece 31D, positions on the other sides of the depth directions of the two slit portions 7, i.e., a position on the left side and a position on the right side in FIG. 3D are closed. The remaining one slit portion 7 is open in the peripheral surface 316 and is not open in the peripheral surface 314. In the peripheral surface 314 out of the outer peripheral surfaces of the first core piece 31D, a position on the other side of the depth direction of the remaining one slit portion 7, i.e., a position near the center in FIG. 3D is closed. As described above, the first core piece 31D includes two sets of slit portions 7 that are shifted from each other in the axial direction and are open in opposite directions.

In cases where a single first core piece includes a plurality of slit portions 7, each slit portion 7 is provided so as to be open only in an outer peripheral surface of the first core piece on one side of the depth direction, and such that not both sides of the depth direction are open. Therefore, magnetic saturation is unlikely to occur in the reactor 1, when compared to a case where the slit portions are provided such that both sides of the depth direction are open. Also, if a single first core piece includes a plurality of slit portions 7, the thickness t₇ of each slit portion 7 can be reduced. If the thickness t₇ is small, magnetic flux leakages from the slit portions 7 are reduced. Consequently, the reactor 1 has low loss and a small size as described above. Also, if the thickness t₇ is small, volumes of regions of the first core pieces 31B to 31D on the closed sides of the slit portions 7 can be made large to a certain extent. For this reason, the reactor 1 has high strength as described above.

Note that all slit portions 7 shown in FIGS. 3A to 3D extend through the opposite peripheral surfaces 313 and 315 and are open in the peripheral surface 314 or 316. Also, the depth directions of the slit portions 7 are orthogonal to the axial directions of the first core pieces 31A to 31D.

In cases where the reactor 1 includes a plurality of slit portions 7, shapes and sizes of the slit portions 7 may be the same or differ from each other. If the plurality of slit portions 7 provided in each of the first core pieces 31B to 31D have the same shape and the same size as shown in FIGS. 3B to 3D, it can be said that the first core pieces 31B to 31D have simple shapes and excellent moldability. Also, magnetic flux leakages from the slit portions 7 and a loss due to the magnetic flux leakages can be easily reduced when compared to a case where a large slit portion 7 is locally provided.

### Formation Position

The slit portion 7 is provided at a suitable position in the axial direction of the first core piece 31a. The slit portion 7 in the first core piece 31a is formed at the center of the axial direction of the first core piece 31a. Such a first core piece 31a has a symmetrical shape about a line segment that halves the first core piece 31a in the axial direction. The first core pieces 31A, 31B, and 31D shown in FIGS. 3A, 3B, and 3D also have symmetrical shapes.

In cases where a single first core piece includes a plurality of slit portions 7, if a distance between adjacent slit portions 7 is set to be wide to a certain extent as shown in FIG. 3B to 3D, strength of the core piece can be easily increased. This is because volumes of regions of the first core pieces 31B to 31D on the closed sides of the slit portions 7 can be made large. Depending on the number of slit portions 7, the distance between adjacent slit portions 7 may be at least 10% of the length of the first core piece and less than 50% of the length of the first core piece, for example. The distance may also be: the length of the first core piece/(the number of slit portions+1), for example.

### Constituent Material of Core Piece

The plurality of core pieces constituting the magnetic core 3 are, for example, molded bodies that are mainly composed of a soft magnetic material. Examples of soft magnetic materials include metals such as iron and iron alloys, e.g., a Fe—Si alloy, a Fe—Ni alloy, etc., and non-metal materials such as ferrite. Examples of the above-described molded bodies include molded bodies of a composite material, pressed powder molded bodies, layered bodies of plate materials composed of the soft magnetic material, and sintered bodies. Molded bodies of the composite material contain a magnetic powder and resin. Details of the molded bodies of the composite material will be described later. Details of pressed powder molded bodies will be described later. Layered bodies of plate materials are typically obtained by stacking plate materials such as electromagnetic steel plates. Atypical example of sintered bodies is a ferrite core. It is possible to use any of the following configurations: a configuration in which constituent materials of all core pieces are the same, a configuration in which constituent materials of all core pieces differ from each other, and a configuration in which constitutional materials of some of the core pieces are the same as is the case with the present example. However, out of the plurality of core pieces constituting the magnetic core 3, for example, the first core piece 31a including the slit portion 7 is constituted by a molded body of the composite material. In the present example, the second core piece 31b mainly arranged in the other wound portion 2b is also constituted by a molded body of the composite material.

### Molded Body of Composite Material

In the molded bodies of the composite material, the amount of magnetic powder contained in the composite material is at least 30 vol % and no greater than 80 vol %, for example. The amount of resin contained in the composite material is at least 10 vol % and no greater than 70 vol %, for example. The larger the amount of magnetic powder is and the smaller the amount of resin is, the easier it is to increase a saturation magnetic flux density and a relative permeability and to enhance heat dissipation. In a case where an increase in the saturation magnetic flux density, an increase in the relative permeability, and enhancement of heat dissipation are desired, for example, the amount of magnetic powder may be at least 50 vol %, at least 55 vol %, or at least 60 vol %. The smaller the amount of magnetic powder is and the larger the amount of resin is, the easier it is to improve electrical insulation to reduce an eddy current loss. The composite material has excellent fluidity in a manufacturing step. In a case where a reduction in loss and an improvement in fluidity are desired, for example, the amount of magnetic powder may be no greater than 75 vol % or no greater than 70 vol %. Alternatively, the amount of resin may be greater than 30 vol %.

In the molded bodies of the composite material, the saturation magnetic flux density and the relative permeability can be easily varied not only by adjusting the amount of magnetic powder and the amount of resin as described above, but also by adjusting the composition of the magnetic powder. The composition of the magnetic powder, the amount of magnetic powder, the amount of resin, and the like can be adjusted such that the reactor 1 has predetermined magnetic characteristics, for example, a predetermined inductance.

Examples of the resin contained in the composite material constituting the molded bodies include thermosetting resin, thermoplastic resin, normal-temperature curable resin, and low-temperature curable resin. Examples of thermosetting resin include unsaturated polyester resin, epoxy resin, urethane resin, and silicone resin. Examples of thermoplastic resin include polyphenylene sulfide (PPS) resin, polytetrafluoroethylene (PTFE) resin, liquid crystal polymers (LCPs), polyamide (PA) resins such as nylon 6 and nylon 66, polybutylene terephthalate (PBT) resin, and acrylonitrile-butadiene-styrene (ABS) resin. In addition, a BMC (Bulk Molding Compound) in which calcium carbonate and glass fibers are mixed with unsaturated polyester, millable silicone rubber, and millable urethane rubber, and the like can be used.

The molded bodies of the composite material may also contain powder of a non-magnetic material in addition to the magnetic powder and the resin. Examples of non-magnetic materials include ceramics such as alumina and silica and various metals. If the molded bodies of the composite material contain powder of a non-magnetic material, heat dissipation can be enhanced. Also, powder of a non-metal non-magnetic material such as a ceramic material has an excellent electrical insulation property and therefore is preferable. The amount of powder of a non-magnetic material may be at least 0.2 mass % and no greater than 20 mass %, for example. This amount may also be set to be at least 0.3 mass % and no greater than 15 mass %, or at least 0.5 mass % and no greater than 10 mass %.

The molded bodies of the composite material can be manufactured using a suitable molding method such as injection molding or cast molding. Typically, a raw material containing the magnetic powder and the resin is prepared, a mold is filled with the raw material in the state of a fluid, and thereafter the fluid is solidified. It is possible to use, as the magnetic powder, powder of the soft magnetic material described above or a powder constituted by powder particles that include coating layers made of an insulating material on surfaces thereof.

In particular, a mold that includes a cavity in which a mold member for forming the slit portion 7 is arranged may be used for the first core pieces 31a and 31A to 31D including the slit portion 7. The mold member is, for example, a flat plate-shaped protruding piece that protrudes from an inner surface of the cavity.

### Pressed Powder Molded Body

Pressed powder molded bodies are typically obtained by molding a powder mixture that contains the above-described magnetic powder and a binder into a predetermined shape through compression molding and then performing heat treatment. Resin can be used as the binder, for example. The amount of binder is about no greater than 30 vol %, for example. When the heat treatment is performed, the binder disappears or is converted to a thermally modified substance. Therefore, the amount of magnetic powder can be easily increased in the pressed powder molded bodies, when compared to the molded bodies of the composite material. The amount of magnetic powder contained in the pressed powder molded bodies is greater than 80 vol %, or at least 85 vol %, for example. As a result of containing a large amount of magnetic powder, the pressed powder molded bodies tend to have a high saturation magnetic flux density and a high relative permeability, when compared to the molded bodies of the composite material containing resin.

### Magnetic Characteristics

The relative permeability of the molded body of the composite material is at least 5 and no greater than 50, for example. The relative permeability of the molded body of the composite material may also be at least 10 and no greater than 45, or may also be further reduced to be no greater than 40, no greater than 35, or no greater than 30. Magnetic saturation is unlikely to occur in a reactor 1 that includes a magnetic core 3 including core pieces, specifically, the core pieces 31a and 31b, that are constituted by molded bodies of the composite material having such a low permeability. Therefore, the thickness t₇ of the slit portion 7 can be reduced. If the thickness t₇ of the slit portion 7 is small, a magnetic flux leakage from the slit portion 7 is reduced. Consequently, the reactor 1 has low loss and a small size as described above.

The relative permeability of the third core pieces 32 arranged outside of the wound portions 2a and 2b is preferably greater than the relative permeability of the molded body of the composite material described above. One of reasons for this is that a magnetic flux leakage between the core pieces 31a and 31b and the third core pieces 32 can be reduced. Consequently, a loss due to the magnetic flux leakage is reduced, and the reactor 1 has low loss. Another reason is that it is easy to make the reactor 1 small while achieving a large inductance, when compared to a case where the relative permeability of the molded body of the composite material is 5 to 50, for example, and the relative permeability of the third core pieces 32 is equal to the relative permeability of the molded body of the composite material.

In particular, if the relative permeability of the third core pieces 32 is at least two times the relative permeability of the molded body of the composite material, a magnetic flux leakage between the core pieces 31a and 31b and the third core pieces 32 is more reliably reduced. The larger the difference between the relative permeability of the molded body of the composite material and the relative permeability of the third core pieces 32 is, the easier it is to reduce the magnetic flux leakage. In a case where a reduction in loss is desired, for example, the relative permeability of the third core pieces 32 may be at least 2.5 times, at least 3 times, at least 5 times, or at least 10 times the relative permeability of the molded body of the composite material.

The relative permeability of the third core pieces 32 may be at least 50 and no greater than 500, for example. The relative permeability of the third core pieces 32 may also be further increased to be at least 80, at least 100, at least 150, or at least 180. If the core pieces 32 have such a high permeability, it is easy to increase the difference in relative permeability between the core pieces 32 and the molded body of the composite material. For example, if the relative permeability of the molded body of the composite material is 50 and the relative permeability of the third core pieces 32 is at least 100, the relative permeability of the third core pieces 32 is at least two times the relative permeability of the molded body of the composite material. If the above-described difference in relative permeability is large, the magnetic flux leakage between the core pieces 31a and 31b and the third core pieces 32 can be further reduced as described above, and the reactor 1 has lower loss. Also, the larger the relative permeability of the third core pieces 32 is, the smaller the third core pieces 32 can be made relative to the core pieces 31a and 31b. For this reason, the reactor 1 can have a smaller size.

Here, the relative permeability is determined as described below.

A ring-shaped sample that has the same composition as the molded body of the composite material, which constitutes each of the core pieces 31a and 31b in this example, and a ring-shaped sample that has the same composition as the third core pieces 32 are prepared. The ring-shaped samples each have an outer diameter of 34 mm, an inner diameter of 20 mm, and a thickness of 5 mm.

A winding wire is wound around each of the ring-shaped samples by 300 turns on the primary side and 20 turns on the secondary side, and a B-H initial magnetization curve is measured in a range where H=0 (Oe) to 100 (Oe).

The maximum value of B/H in the obtained B-H initial magnetization curve is determined. The maximum value is taken to be the relative permeability. The magnetization curve referred to here is what is called a direct current magnetization curve.

The ring-shaped sample used in the measurement of the relative permeability of each of the core pieces 31a and 31b does not include the slit portion 7.

The first core piece 31a and the second core piece 31b in the present example are constituted by the molded bodies of the composite material. The third core pieces 32 in the present example are constituted by pressed powder molded bodies. The relative permeability of each of the core pieces 31a and 31b is at least 5 and no greater than 50. The relative permeability of the third core pieces 32 is at least 50 and no greater than 500 and is at least two times the relative permeability of the core pieces 31a and 31b.

Note that the first core piece 31a and the second core piece 31b in the present example are constituted by the molded bodies of the composite material having the same composition, except for the presence and the absence of the slit portion 7 as described above. Therefore, relative permeabilities of the core pieces 31a and 31b are substantially equal to each other. The core pieces 31a and 31b may be constituted by composite materials having different compositions.

### Holding Member

In addition, the reactor 1 may also include a holding member 5 that is interposed between the coil 2 and the magnetic core 3. FIG. 1 virtually shows the holding member 5 with two-dot chain lines.

The holding member 5 is typically constituted by an electrically insulating material and contributes to an improvement in electrical insulation between the coil 2 and the magnetic core 3. Also, the holding member 5 is used to position the core pieces 31a, 31b, and 32 relative to the wound portions 2a and 2b by holding the wound portions 2a and 2b and the core pieces 31a, 31b, and 32. The holding member 5 typically holds the core pieces 31a and 31b such that predetermined gaps are formed between the wound portions 2a and 2b and the core pieces 31a and 31b. In a case where the reactor 1 includes a resin molded portion 6, which will be described later, the gaps can be used as flow paths for a fluid state resin. Accordingly, the holding member 5 also contributes to forming the flow paths in a manufacturing step of the resin molded portion 6.

The holding member 5 shown in FIG. 1 is a rectangular frame-shaped member that is located at positions where end portions of the core pieces 31a and 31b are in contact with the third core pieces 32 and in the vicinities of the positions. The holding member 5 includes, for example, through holes, support pieces, coil side groove portions, and core side groove portions, which will be described below. Details of the holding member 5 are not illustrated. An outer interposed portion 52 in JP 2017-135334A can be referred to as a portion that has a similar shape. In the following description, sides of the holding member 5 on which the third core pieces 32 are arranged will be referred to as “core sides”. Sides of the holding member 5 on which the wound portions 2a and 2b are arranged will be referred to as “coil sides”.

The through holes extend from the core sides to the coil sides of the holding member 5, and the core pieces 31a and 31b are inserted into the through holes. The support pieces protrude from portions of inner peripheral surfaces that form the through holes, and support portions, e.g., corner portions, of outer peripheral surfaces of the core pieces 31a and 31b. When the core pieces 31a and 31b are held by the support pieces, gaps that correspond to thicknesses of the support pieces are formed between the wound portions 2a and 2b and the core pieces 31a and 31b. The coil side groove portions are provided on the coil sides of the holding member 5, and end faces of the wound portions 2a and 2b and regions near the end faces are fitted in the coil side groove portions. The core side groove portions are provided on the core sides of the holding member 5, and surfaces of the third core pieces 32 that are in contact with the core pieces 31a and 31b and regions near the surfaces are fitted in the core side groove portions.

The shape, size, and the like of the holding member 5 can be changed as appropriate so long as the holding member 5 has the above-described function. Also, a known configuration can be used in the holding member 5. For example, the holding member 5 may also include a member that is independent of the above-described frame-shaped member and is arranged between the wound portions 2a and 2b and the core pieces 31a and 31b. The inner interposed portion 51 in JP 2017-135334A can be referred to as a portion that has a similar shape.

The constituent material of the holding member 5 may be an electrically insulating material such as resin. Specific examples of resin are described above with respect to the molded bodies of the composite material. Typical examples of resin include thermoplastic resin and thermosetting resin. The holding member 5 can be manufactured using a known molding method such as injection molding.

### Resin Molded Portion

In addition, the reactor 1 may also include the resin molded portion 6 that covers at least a portion of the magnetic core 3. FIG. 1 virtually shows the resin molded portion 6 with a two-dot chain line.

The resin molded portion 6 functions to protect the magnetic core 3 from an external environment, mechanically protect the magnetic core 3, and improve electrical insulation between the magnetic core 3 and the coil 2 or a component in a surrounding region by covering at least a portion of the magnetic core 3. If the resin molded portion 6 covers the magnetic core 3 and does not cover outer peripheries of the wound portions 2a and 2b to expose the outer peripheries as shown in FIG. 1, the reactor 1 has excellent heat dissipation performance. This is because a cooling medium such as a liquid refrigerant can be brought into direct contact with the wound portions 2a and 2b.

In an example configuration, the resin molded portion 6 includes inner resin portions 61 and outer resin portions 62 as shown in FIG. 1. The inner resin portions 61 are present inside the wound portions 2a and 2b and cover at least portions of the core pieces 31a and 31b. The outer resin portions 62 are present outside the wound portions 2a and 2b and cover at least portions of the third core pieces 32. A configuration is also possible in which the resin molded portion 6 is a single piece molded body in which the inner resin portions 61 are continuous to the outer resin portions 62, and holds the core pieces 31a, 31b, and 32 constituting the magnetic core 3 as a single piece. If the core pieces 31a, 31b, and 32 constituting the magnetic core 3 are held as a single piece by the resin molded portion 6, rigidity of the magnetic core 3 as the single piece is increased, and the reactor 1 has excellent strength.

In addition, in a case where the holding member 5 includes a member that is arranged between the wound portions 2a and 2b and the core pieces 31a and 31b, for example, a configuration is also possible in which the resin molded portion 6 does not include the inner resin portions 61 and substantially covers only the third core pieces 32. In a case where the resin molded portion 6 includes the inner resin portions 61, a portion of the inner resin portions 61 fills the interior space of the slit portion 7 and functions as a resin gap. In a case where the resin molded portion 6 does not include the inner resin portions 61, the slit portion 7 functions as an air gap.

Areas that are covered by the inner resin portions 61 and the outer resin portions 62 and thicknesses and the like of the inner resin portions 61 and the outer resin portions 62 can be appropriately selected. For example, the resin molded portion 6 may also cover the entire outer peripheral surface of the magnetic core 3. Alternatively, a configuration is also possible in which the outer resin portions 62 do not cover portions of the third core pieces 32 to expose the portions. Also, the resin molded portion 6 may have a substantially uniform thickness or have a local variation in thickness. In addition, the resin molded portion 6 may also be configured such that the inner resin portions 61 only cover portions of the core pieces 31a and 31b that are joined with the core pieces 32 and the vicinities of the portions. Alternatively, a configuration is also possible in which the resin molded portion 6 does not include the inner resin portions 61 and substantially covers only the core pieces 32.

Various types of resin may be used as the constituent material of the resin molded portion 6. For example, thermoplastic resin may be used. Examples of thermoplastic resin include PPS resin, PTFE resin, LCP, PA resin, and PBT resin. The constituent material may also contain a powder that has an excellent heat conduction property or powder of the above-described non-magnetic material, in addition to the resin. A resin molded portion 6 that contains such a powder has an excellent heat dissipation property. In addition, if the resin constituting the resin molded portion 6 is the same as the resin constituting the holding member 5, the resin molded portion 6 and the holding member 5 can be favorably bonded. Also, the resin molded portion 6 and the holding member 5 have the same thermal expansion coefficient, and therefore the resin molded portion 6 can be kept from separating or cracking due to thermal stress. The resin molded portion 6 can be molded through injection molding or the like.

### Manufacturing Method of Reactor

The reactor 1 in the first embodiment can be manufactured by preparing the core pieces 31a, 31b, and 32 and attaching the coil 2, for example. The holding member 5 is attached as appropriate. A reactor 1 that includes the resin molded portion 6 can be manufactured by placing the coil 2, the magnetic core 3, and the holding member 5, which are assembled, in a mold for the resin molded portion 6, and covering the magnetic core 3 with a fluid state resin. Illustration of the mold is omitted.

The core piece 31a constituted by the molded body of the composite material can be manufactured through injection molding or the like using a mold including a cavity in which a mold member for forming the slit portion 7 is arranged as described above.

The resin molded portion 6 can be manufactured using a unidirectional filling method in which a fluid state resin is introduced to flow from one of the core pieces 32 toward the other core piece 32. Alternatively, it is also possible to use two-directional filling method in which the fluid state resin is introduced to flow from the two core pieces 32 toward the inside of the wound portions 2a and 2b.

### Application

The reactor 1 of the first embodiment can be used as a component of a circuit that performs a voltage step-up operation or a voltage step-down operation, and for example, can be used as a constituent component of various types of converters and power conversion apparatuses. Examples of converters include an in-vehicle converter (typically a DC-DC converter) mounted in a vehicle such as a hybrid automobile, a plug-in hybrid automobile, an electric automobile, or a fuel cell automobile, and a converter for an air conditioner.

### Major Effects

In the reactor 1 of the first embodiment, the slit portion 7 included in the first core piece 31a can be used as a magnetic gap. The first core piece 31a is constituted by the molded body of the composite material and the resin contained in the composite material also functions as a magnetic gap, and therefore magnetic saturation is unlikely to occur. For these reasons, magnetic saturation is unlikely to occur in the reactor 1 even if a large current value is used.

Also, in the reactor 1 of the first embodiment, the slit portion 7 and the first core piece 31a are formed as a single piece. Therefore, a gap plate or the like is unnecessary, the number of assembled parts is small, and the reactor 1 can be easily assembled. There is no need to bond the core pieces and the gap plate with an adhesive, and the time it takes to solidify the adhesive can be eliminated. Therefore, the reactor 1 has excellent manufacturability. The first core piece 31a is constituted by the molded body of the composite material, and therefore can be easily molded through injection molding or the like although the first core piece 31a includes the slit portion 7. Consequently, the reactor 1 has excellent manufacturability.

Furthermore, the reactor 1 of the first embodiment has the following effects.

The slit portion 7 is arranged inside of the wound portion 2a. Therefore, a magnetic flux leakage from the slit portion 7 is reduced when compared to a case where the slit portion 7 is arranged outside of the wound portion 2a. Therefore, the reactor 1 can reliably have a predetermined inductance.

Magnetic saturation is unlikely to occur in the first core piece 31a constituted by the molded body of the composite material, when compared to a layered body of electromagnetic steel plates and a pressed powder molded body. Therefore, the thickness t₇ of the slit portion 7 can be reduced. If the thickness t₇ of the slit portion 7 is small, a magnetic flux leakage from the slit portion 7 is reduced. Even if the wound portion 2a and the first core piece 31a are arranged close to each other, a loss due to the above-described magnetic flux leakage, e.g., a copper loss, is reduced. Furthermore, the first core piece 31a has an excellent electrical insulation property as a result of containing resin, and therefore the wound portion 2a and the first core piece 31a can be arranged close to each other. If the wound portion and the first core piece are arranged close to each other, the reactor 1 can be easily made small. Therefore, the reactor 1 has low loss and a small size.

The first core piece 31a constituted by the molded body of the composite material has an excellent electrical insulation property as a result of containing resin, and therefore an eddy current loss is reduced. An alternating current loss such as an iron loss is reduced, and therefore the reactor 1 has low loss.

The first core piece 31a has excellent mechanical strength because the volume of the region of the first core piece 31a on the closed side of the slit portion 7 can be made large to a certain extent. A reactor 1 including such a first core piece 31a has excellent strength.

### Second Embodiment

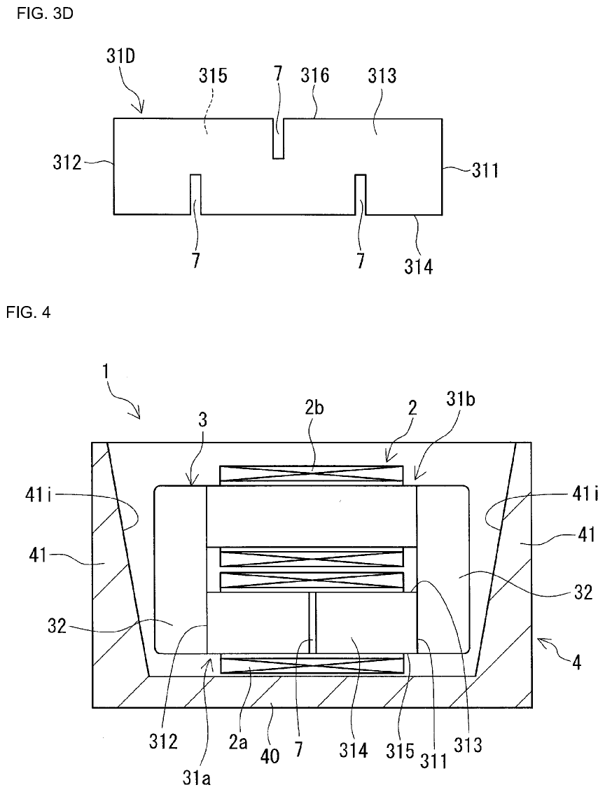

The following describes a reactor 1 of a second embodiment mainly with reference to FIG. 4.

FIG. 4 shows a cross section of a case 4 by cutting the case 4 along a plane that is parallel with a depth direction of the case 4 to facilitate understanding of the inside of the case 4. Also, FIG. 4 shows a cross section of the coil 2 by cutting the coil 2 along a plane that is parallel with the axial directions of the wound portions 2a and 2b.

The basic configuration of the reactor 1 of the second embodiment is the same as that in the first embodiment. An outline will be described. The reactor 1 of the second embodiment includes the coil 2 including the wound portions 2a and 2b and the magnetic core 3 including the core pieces 31a, 31b, and 32. The first core piece 31a mainly accommodated in the wound portion 2a is constituted by a molded body of a composite material. The first core piece 31a includes the slit portion 7 in a region that is arranged inside of the wound portion 2a. In the present example, the second core piece 31b mainly accommodated in the other wound portion 2b is also constituted by a molded body of a composite material. The second core piece 31b does not include the slit portion 7. The composite materials constituting the core pieces 31a and 31b have substantially the same composition and the like.

In particular, a difference between the first and second embodiments is that the reactor 1 of the second embodiment includes the case 4 that accommodates the set of the coil 2 and the magnetic core 3. The following describes the case 4 in detail and omits detailed descriptions of configurations and effects that overlap those in the first embodiment.

The constituent material of the case 4 is preferably metal. This is because metal is superior to resin in terms of heat conductivity, and therefore a case 4 made of metal can be used as a heat dissipation path for the above-described set. Specific examples of metal include aluminum and aluminum alloys.

There is no limitation on the shape and the size of the case 4 so long as the case 4 can accommodate the above-described set. As shown in FIG. 4, the case 4 in the present example is a box-shaped body including a flat plate-shaped bottom portion 40 and wall portions 41 that protrude from the bottom portion 40. In the present example, an inner wall surface 41i of each wall portion 41 is inclined and is not orthogonal to the bottom portion 40. Specifically, the inner wall surface 41i is inclined relative to the bottom portion 40 such that an opening width increases from the bottom portion 40 side toward the opening side. In the present example, the opening width is the length along the left-right direction in FIG. 4. As a result of the inner wall surface 41i being inclined as described above, the case 4 has excellent manufacturability. This is because the case 4 can be easily taken out from a mold when the case 4 is manufactured through casting or the like. The wall portions 41 may also be provided such that the inner wall surface 41i is orthogonal to the bottom portion 40.

The set including the coil 2 and the magnetic core 3 is accommodated in the case 4 as described below. The first core piece 31a including the slit portion 7 and the wound portion 2a in which the first core piece 31a is arranged are located on the side close to the bottom portion 40 of the case 4. The second core piece 31b that does not include the slit portion 7 and the other wound portion 2b in which the second core piece 31b is arranged are located on the side close to the opening of the case 4. In the present example, the bottom portion 40 of the case 4 is placed on an installation target that includes a cooling mechanism. As a result, the first core piece 31a including the slit portion 7 and the wound portion 2a are arranged on the side close to the installation target. Also, the second core piece 31b that does not include the slit portion 7 and the other wound portion 2b are arranged on the side far from the installation target, which is the open side of the case 4 in this example. Note that illustration of the cooling mechanism and the installation target is omitted.

### Major Effects

The reactor 1 of the second embodiment has excellent heat dissipation performance as described below. In the wound portion 2a in which the first core piece 31a including the slit portion 7 is arranged, it is likely that heat is generated due to a magnetic flux leakage from the slit portion 7, when compared to the other wound portion 2b in which the second core piece 31b that does not include the slit portion 7 is arranged. However, as a result of the case 4, in particular, the bottom portion 40 being cooled by the installation target, the first core piece 31a and the wound portion 2a can efficiently conduct heat to the installation target via the bottom portion 40 of the case 4.

The present disclosure is not limited to these examples but is indicated by the claims, and all modifications that fall within the meaning and range of equivalency with the claims are intended to be encompassed therein.

For example, at least one of the following modifications is possible in the above-described first and second embodiments.

### MODIFIED EXAMPLE A

In a case where the coil includes two wound portions, core pieces including regions thereof that are respectively arranged in the wound portions each have a slit portion.

With this configuration, the number of slit portions can be increased. Accordingly, the thickness of the slit portion included in each core piece can be reduced. If the thickness of the slit portion is small, a magnetic flux leakage from the slit portion is reduced. Consequently, the reactor 1 has low loss and a small size as described above. Also, the core pieces mainly arranged in the wound portions can be molded using a single mold. Therefore, molds of different types are unnecessary and a manufacturing cost is reduced.

### MODIFIED EXAMPLE B

The first core piece has a shape other than the rectangular parallelepiped shape.

For example, the first core piece may also have a circular column shape or an elliptical column shape. In this case, a portion of the opening edge of the slit portion extending along the peripheral direction of the first core piece typically has a circular arc shape or an elliptical arc shape. The shape of an inner wall surface forming the slit portion may be a curved shape defined by the opening edge having the circular arc shape or the elliptical arc shape and a chord or a straight line connecting both ends of the opening edge. If the length of the opening edge of the slit portion along the peripheral direction of the first core piece is at least ⅓ and no greater than ½ of the perimeter of the first core piece, magnetic saturation is unlikely to occur in the reactor of this configuration, the mold member can be easily taken out, and the reactor has excellent manufacturability as described above. In particular, in a case where the first core piece has an elliptical column shape, the depth direction of the slit portion is preferably a direction extending along a short side of an imaginary rectangle that is assumed with respect to a cross section of the first core piece as described above.

### MODIFIED EXAMPLE C

The first core piece has the rectangular parallelepiped shape, and the slit portion is open only in one of the four peripheral surfaces and is closed in the remaining three peripheral surfaces.

If the length of the above-described opening edge of the slit portion is long to a certain extent, for example, at least ⅓ of the perimeter of the first core piece as described above, the slit portion of this configuration effectively functions as a magnetic gap. However, as is the case with the slit portion 7 described in the first embodiment, if the slit portion 7 is continuously open in the three peripheral surfaces 313 to 315 of the four peripheral surfaces 313 to 316 of the first core piece 31a having the rectangular parallelepiped shape, the mold member for forming the slit portion 7 can be easily taken out. Such a first core piece 31a has excellent manufacturability.

### MODIFIED EXAMPLE D

Inner wall surfaces forming the slit portion intersect an outer peripheral surface of the first core piece at an angle other than 90°.

The modified example D will be described with reference to FIG. 3A. The first core piece 31A shown in FIG. 3A includes the inner wall surfaces 71 and the inner bottom surface 70 that form the slit portion 7A. The inner wall surfaces 71 each intersect an outer peripheral surface, which is the peripheral surface 314 in this example, of the first core piece 31A at an angle other than 90°. FIG. 3A shows an example in which an intersection angle of the inner wall surfaces 71 relative to the peripheral surface 314 is larger than 90°. The inner wall surfaces 71 are inclined such that the distance between the inner wall surfaces 71 facing each other increases from the inner bottom surface 70 side toward the opening of the slit portion 7A. The inner bottom surface 70 is arranged along the axial direction of the first core piece 31A. Accordingly, the slit portion 7A is open in a trapezoidal shape in the peripheral surface 313.

The slit portion 7A can be formed using a mold member that has a column shape including a trapezoidal end face. The mold member having such a shape can be easily taken out from the slit portion 7A after the first core piece 31A is molded. Therefore, the first core piece 31A can be easily molded and this configuration further improves manufacturability.

### MODIFIED EXAMPLE E

All core pieces constituting the magnetic core are constituted by molded bodies of the composite material.

In this configuration, magnetic saturation is less likely to occur, when compared to the first embodiment that includes molded bodies of the composite material and pressed powder molded bodies, for example. Therefore, the thickness of the slit portion can be reduced. The reactor has low loss because a magnetic flux leakage from the slit portion is reduced. Also, each core piece has an excellent electrical insulation property, and an eddy current loss is reduced. An alternating current loss such as an iron loss is reduced, and therefore the reactor has low loss.

### MODIFIED EXAMPLE F

The number of core pieces constituting the magnetic core is two, three, or five or more.

As the number of core pieces is reduced, the number of assembled parts of the reactor is reduced and manufacturability of the reactor is improved. As the number of core pieces is increased, the freedom in choosing constituent materials of the core pieces is increased as described in the first embodiment, and magnetic characteristics and the like can be easily adjusted.

In cases where the number of core pieces is two, the following configurations are possible: a configuration that includes two U-shaped core pieces, a configuration that includes two L-shaped core pieces, and a configuration that includes a U-shaped core piece and an I-shaped core piece. In any of these configurations, a core piece that is constituted by a molded body of the composite material can be included, and the slit portion can be provided in a region of the core piece that is arranged in a wound portion.

### MODIFIED EXAMPLE G

The second core piece is other than the molded body of the composite material.

For example, the second core piece may be a pressed powder molded body.

### MODIFIED EXAMPLE H

A core piece that includes a region thereof arranged in a wound portion has an outer peripheral shape that is not analogous to an inner peripheral shape of the wound portion.

This configuration makes it easy to make a gap between the wound portion and the core piece wide. Therefore, a loss due to a magnetic flux leakage from the slit portion, e.g., a copper loss, can be reduced.

### MODIFIED EXAMPLE I

The reactor includes at least one of the following (none are shown in the drawings).

(I-1) The reactor includes a sensor that measures a physical amount of the reactor, such as a temperature sensor, a current sensor, a voltage sensor, or a magnetic flux sensor.

(I-2) The reactor includes a heat dissipation plate that is attached to at least a portion of outer peripheral surfaces of the wound portions of the coil.

Examples of the heat dissipation plate include a metal plate and a plate material composed of a non-metal inorganic material with an excellent thermal conductivity. In particular, if the heat dissipation plate is provided on a wound portion in which the first core piece including the slit portion is arranged, the reactor has excellent heat dissipation performance, which is preferable. This is because it is likely that heat is generated in the wound portion in which the first core piece including the slit portion is arranged, when compared to the other wound portion in which the second core piece that does not include the slit portion is arranged. The heat dissipation plate may also be provided on the wound portion in which the first core piece is not arranged.

(I-3) The reactor includes a bonding layer that is interposed between an installation surface of the reactor and the installation target, between the installation surface and an inner bottom surface of the case 4 (see FIG. 4), or between the installation surface and the above-described heat dissipation plate.

Examples of the bonding layer include an adhesive layer. If an adhesive layer that has an excellent electrical insulation property is used, even if the heat dissipation plate is a metal plate, insulation between the wound portion and the heat dissipation plate is improved by the adhesive layer, which is preferable.

(I-4) The reactor includes an attachment portion for fixing the reactor to the installation target, the attachment portion and an outer resin portion being molded as a single piece.

1. A reactor comprising:
a coil that includes a wound portion; and
a magnetic core that is arranged inside of the wound portion and outside of the wound portion,
wherein the magnetic core is formed by combining a plurality of core pieces,
at least one core piece of the plurality of core pieces is a first core piece that is constituted by a molded body of a composite material containing a magnetic powder and a resin,
the first core piece includes a slit portion in a region that is arranged inside of the wound portion,
a depth direction of the slit portion extends along a direction that intersects an axial direction of the first core piece, and
the slit portion is provided so as to be open in an outer peripheral surface of the first core piece on one side of the depth direction and be closed on the other side.

2. The reactor according to claim 1, wherein a size of depth of the slit portion along a direction orthogonal to the axial direction is at least ⅓ and no greater than ½ of a length of the first core piece along the direction orthogonal to the axial direction.

3. The reactor according to claim 1, wherein the first core piece includes a plurality of the slit portions.

4. The reactor according to claim 1, wherein the depth direction of the slit portion is a direction that extends along a short side of an imaginary rectangle that is the minimum rectangle in which an external shape of a cross section of the first core piece is included, the cross section being taken by cutting the first core piece along a plane that is orthogonal to the axial direction.

5. The reactor according to claim 1, wherein the coil includes two said wound portions that are adjacent to each other, and
the magnetic core includes:
the first core piece including the slit portion arranged inside of one of the wound portions; and
a second core piece that includes a region arranged inside of the other wound portion, is constituted by a molded body of the composite material, and does not include the slit portion.

6. The reactor according to claim 1, wherein a length of an opening edge of the slit portion along a peripheral direction of the first core piece is at least ⅓ and no greater than ½ of a perimeter of the first core piece.

7. The reactor according to claim 1 wherein a relative permeability of the molded body of the composite material is at least 5 and no greater than 50, and
a relative permeability of a third core piece that is arranged outside of the wound portion is at least two times the relative permeability of the molded body of the composite material.

8. The reactor according to claim 7, wherein the relative permeability of the third core piece is at least 50 and no greater than 500.

9. The reactor according to claim 1, further comprising:
a resin molded portion that covers at least a portion of the magnetic core.
